(19) United States
(12) Patent Application Publication
(10) Pub. No.: US 2026/0054465 A1
(43) Pub. Date: Feb. 26, 2026

(54) HIGH PRESSURE HOSES FOR THE DELIVERY OF HYDROGEN OR GASOLINE

(71) Applicant: ContiTech Deutschland GmbH, Hannover (DE)

(72) Inventors: Lance Miller, Uniontown, OH (US); Steffen Wietzke, Uetze (DE); Stefan Krause, Krause (DE); Alexander Schmidt, Göttingen (DE)

(73) Assignee: ContiTech Deutschland GmbH, Hannover (DE)

(21) Appl. No.: 19/104,680

(22) PCT Filed: Jul. 31, 2023
(86) PCT No.: PCT/EP2023/071119

§ 371 Date: Feb. 18, 2025

Related U.S. Application Data
(60) Provisional application No. 63/373,329, filed on Aug. 24, 2022.

(51) Int. Cl. B32B 1/08; B32B 15/02; B32B 15/082; B32B 25/08; B32B 25/14; B32B 27/30

(52) U.S. Cl. CPC B32B 1/08; B32B 15/02; B32B 15/082; B32B 25/08; B32B 25/14; B32B 27/306; B32B 2262/02; B32B 2270/00; B32B 2307/202; B32B 2307/54; B32B 2307/724; B32B 2307/7375; B32B 2307/7376; B32B 2311/00; B32B 2313/04; B32B 2329/04

(57) ABSTRACT

Hoses with a burst pressure of at least 5.5 bar, wherein the hose has a layered structure with an inner barrier layer of a blend of ethylene vinyl alcohol copolymer and an aliphatic polyketone, at least one reinforcement layer and optionally an outer layer formed from a polymeric material. Such high pressure hoses are characterized by a very favorable property profile for use with hydrogen at high pressures. Also provided are methods for manufacturing such hoses, tank filling devices equipped with such hoses, and uses of corresponding high-pressure hoses for transferring hydrogen from a storage container to a tank.

The present invention relates to a reinforced hose having a burst pressure of at least 5.5 bar, the hose having a layered structure comprising a barrier layer of a blend of ethylene vinyl alcohol copolymer and an aliphatic polyketone, at least one strength-bearing layer and an optionally outer layer formed of a polymeric material. The present invention further relates to a method for manufacturing such hoses, tank filling devices equipped with such hoses, and uses of corresponding reinforced hoses for transferring hydrogen or other gases from a storage container into a tank.

### STATE OF THE ART

In recent years, the development of fuel cell vehicles has experienced a significant boost. However, hydrogen as a fuel places considerable demands on the materials used to store and transport the hydrogen, which result from the small molecular size of hydrogen. One aspect of this is the development of hoses through which a fuel cell vehicle and the like can be filled with hydrogen gas from a dispenser installed at a hydrogen station. To increase the driving distance of a fuel cell vehicle, a fuel tank must be filled with hydrogen gas under high pressure. Therefore, such hoses used for filling with hydrogen must withstand high internal pressures of e.g. 70 MPa or more at a relatively wide temperature window (−40° C. to about 85° C. on the vehicle side).

Materials for the inner layer of such hoses must meet a number of requirements, such as in particular a low permeability to hydrogen, but also a certain flexibility so that the hose can be connected to the motor vehicle by a user, and of course sufficient strength properties. Barrier materials for an inner layer of tubing that have been described to date include nylon (e.g. in the form of nylon 6, nylon 66, or nylon 11), polyacetal, or ethylene vinyl alcohol copolymer, PEEK or NBR (nitrile butadiene rubber).

For example, EP 3 627 026 A1 describes hydrogen fuel hoses with an inner and outer layer and three or more reinforcing layers having a precisely specified braid angle of 53.5 to 55.5°. In one embodiment of EP 3 627 026 A1, the inner layer is formed of nylon and the outer layer is formed of polyester.

JP 2017-106553 A describes hydrogen hoses with high burst resistance, which have reinforcing layers of polyparaphenylenebenzbisoxazole fibres in addition to inner and outer layers, with which a service pressure of 70 MPa can be achieved. Elaflex markets a hydrogen hose for mobility applications that has an inner NBR layer modified to impart electrical conductivity, multiple layers of low-stretch textile braid and an outer layer of chloroprene rubber (see https://elaflex.de/dokumente/download/ElaflexInformation/ELAFLEX_Information 1.20.pdf).

In addition, hoses have been described for high-pressure applications in the context of oil and gas production, which are subject to strong pressure differences and tensile forces when used below the water surface. For example, US 2001/021426 A1 discloses unbonded hoses with a fluid impermeable barrier layer, reinforcing layers and an outer layer. As the innermost layer, these hoses have a flexible metal cylinder which is intended to provide the required mechanical strength and flexibility. The hoses are designed accordingly for applications where high pressures act on the hose from the outside.

Since the barrier layer material in hoses for the passage of hydrogen at high pressure must meet various requirements, there is the problem of providing materials that have a favorable overall property profile. For example, ethylene vinyl alcohol copolymers (EVOH) have very low permeability to hydrogen gas but do not have satisfactory mechanical and strength properties (e.g. tensile strength, elongation at break or notched impact strength). In particular, ethylene vinyl alcohol copolymers tend to have high flexural modulus, which makes it difficult to bend the material and also exhibit a high stiffness, which results in a low elongation at break. While the flexibility of ethylene vinyl alcohol copolymers can be increased by raising the ethylene content (i.e. lowering the alcohol content) or by including plasticizers, this comes at the tradeoff of a higher gas permeation rate.

An additional difficulty with EVOH is, that it shows a higher loss in permeation resistance on increase of the temperature above ambient temperature, which is higher than for other polymers (e.g. by a factor of 120 on increase of the temperature of from 30° C. to 85° C. compared to a factor of 10 for polyketone). This effect is most noticeable when the temperature is near the glass transition temperature, which for EVOH is between 50-65° C. This is within the range of service temperatures for a multilayer hydrogen dispensing hose.

Other polymeric materials, which have been used as barrier materials for hydrogen, include polyamides such as nylon 6 or nylon 11, which however are not fully satisfactory as these polyamides have comparatively low tensile strength and the permeability to hydrogen gas is unsatisfactory, especially under elevated temperatures such as +85° C. Further barrier materials such as PEEK (=polyetheretherketone) have very favorable mechanical properties and in particular a very high tensile strength, but can only be processed at very high temperatures of more than 340° C. Also, PEEK has unsatisfactory hydrogen permeability.

Against the background of this state of the art, there is a need for a barrier material that has a low permeability to hydrogen and that simultaneously imparts favorable flexibility and mechanical properties and can be processed at lower temperatures than, for example, PEEK. Furthermore, such a material should preferably allow the incorporation of additives to impart electrical conductivity without significantly impairing the mechanical and permeability properties of the material. In addition, the material should preferably provide good temperature resistance over the service temperature of a hydrogen filling hose and improved adhesion to outer layers of a hose construction.

The present invention addresses this need.

### DESCRIPTION OF THE INVENTION

In the investigations underlying this invention, the inventors have surprisingly found that blending an ethylene vinyl alcohol copolymer with an aliphatic polyketone provides a highly favourable property profile with suitable flexibility and mechanical properties, low hydrogen permeability and good temperature resistance over the service temperature range of a hydrogen high pressure hose. In addition, the blend is processable via extrusion and allows the inclusion of additives to impart electrical conductivity and has better adhesive properties that ethylene vinyl alcohol copolymer alone. Relative to the sole use of aliphatic polyketone in the barrier layer, the blend with ethylene vinyl alcohol copolymer provides for improved flexibility and gas barrier properties.

Accordingly, in accordance with a first aspect, the present invention relates to a reinforced hose having burst pressure of at least 5.5 bar, wherein the hose has a layered structure comprising an inner barrier layer, at least one strength-bearing layer and optionally an outer layer formed from a polymeric material, and wherein the barrier layer is formed from a blend of an ethylene vinyl alcohol copolymer and an aliphatic polyketone of the formula

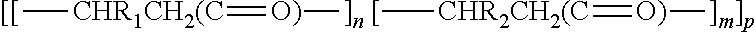

wherein R₁ and R₂ are different from each other and independently represent hydrogen or a C₁-C₁₂ alkyl group, n+m=1, and p is an integer, and wherein the two comonomers are randomly distributed or present as blocks. The above formula indicates that the polymer comprises [—CHR₁CH₂(C═O)—] and [—CHR₂CH₂ (C═O)—] units, where “n” and “m” are respective indicators of the ratio of the units in the polymer. The formula above should not be construed a defining a particular sequence of the units, which as noted can be present “randomly distributed or as blocks” in the polyketone.

The term “formed from” in the above is to be understood in that the blend is the primary constituent of the barrier layer, while the presence of further constituents is possible. Regularly, the barrier layer will contain the blend in an amount of at least 50 wt.-%, preferably in an amount of 60 to 95 wt.-% and more preferably in an amount of form 70 to 90 wt.-%.

The ethylene vinyl alcohol copolymer in the above blend preferably comprises units derived from ethylene in an amount of from 23 to 48 mol %, more preferably 23 to 35 mol % and more even preferably of from 24 to 30 mol %. Such copolymers provide favourable barrier and mechanical characteristics. In addition, it is preferred that the ethylene vinyl alcohol copolymer at most contains minor amounts of monomers, which are other than ethylene and vinyl alcohol. Such monomers are most notably vinyl acetate from an ethylene vinyl acetate precursor of the ethylene vinyl alcohol copolymer. Accordingly, it is preferred that the content of such other monomers is at most 1 mol %, more preferably at most 0.5 mol % and even more preferably at most 0.2 mol %. 20

In the indicated aliphatic polyketone, when R₁ and/or R₂ represents a C₁-C₁₂ alkyl group, the C₁-C₁₂ alkyl group is preferably selected from methyl, ethyl, propyl, pentyl or heptyl.

In a particularly preferred embodiment, R₁ is a methyl group and R₂ is H. When R₁ is a C₁-C₁₂ alkyl group, “n” is preferably less than 0.5, in particular less than 0.15, and particularly preferably between 0.02 and 0.14; for such values of n, it is preferred when R₁ is a methyl group and R₂ is H. In another embodiment, n=0 and R₂ is has, in which case the aliphatic polyketone is present as poly(ethylene ketone).

“p” is preferably an integer between 500 and 5000.

In one embodiment of the present invention, the aliphatic polyketone is semi-crystalline. Partial crystallinity can be detected by DSC measurements of the polymer.

In a preferred embodiment of the present invention, the aliphatic polyketone polymer contains at least 80 weight.-%, in particular at least 90 weight.-%, and particularly preferably at least 95 weight.-% of the structural units, which are indicated in the formula above. Other structural units, which may in addition be present, include most notably products from the insertion of two alkyene units without an intermediate CO.

Alternatively or in addition thereto, the aliphatic polyketone has a melting temperature between 180° C. and 250° C., preferably 109° C. to 220° C.

Furthermore, it is preferred in the context of the present invention if the aliphatic polyketone has a weight average molecular weight M_{w} of at least 40,000 g/mol, and in particular at least 60,000 g/mol. In a particularly preferred embodiment of the present invention, the aliphatic polyketone has a molecular weight of at least 200,000 g/mol.

In the present invention it is further preferred that the aliphatic polyketone has a weight average molecular weight M_{w} of 140000 g/mol to 410000 g/mol, more preferably a weight average molecular weight of 1500000 g/mol to 210000 g/mol or of 290000 g/mol to 400000 g/mol, and most preferably a weight average molecular weight of 1600000 g/mol to 200000 g/mol or of 300000 g/mol to 390000 g/mol. The weight-average molecular weight M_{w} is to be determined here by GPC using suitable standards (e.g. polystyrene).

A commercially available aliphatic polyketone that can be used for the production of the barrier layer of the reinforced hoses according to the invention are the products marketed by Hyosung under the trade name POKETONE.

In a particularly preferred embodiment, the blend, which forms the barrier layer, has an overall gas permeability to hydrogen (H₂) of 1000 mm*cm^{3*}m⁻²*d⁻¹ bar⁻¹ or less (determined according to DIN 53880 (2006) at 30° C. and bar, 0% relative humidity)), in particular 800 mm*cm^{3*}m⁻²*d⁻¹ bar⁻¹ or less and particularly preferably 500 mm*cm^{3*}m⁻²+d⁻¹ bar⁻¹ or less.

The aliphatic polyketone can be processed by extrusion, for example. The ratio of the ethylene vinyl alcohol copolymer and the aliphatic polyketone is not subject to any relevant restriction, as long as the blend provides the desired effects in terms of barrier properties and mechanical strength. In a preferred embodiment, the ratio of ethylene vinyl alcohol copolymer and the aliphatic polyketone is adjusted in a range from 10:90 to 60:40, where an adjustment in the range of 10:80 to 45:55 is more highly preferred.

Next to the ethylene vinyl alcohol copolymer and the aliphatic polyketone the blend may comprise a compatibilizer, which ameliorates the formation of a stable blend between the ethylene vinyl alcohol copolymer and the aliphatic polyketone. Suitable compatibilizers include e.g. polymers and preferably copolymers with a non-polar monomer (such as an olefin) and a polar monomer (such as an acidic monomer). Regularly in such copolymers, the non-polar monomer is present in an excess over the polar monomer of at least 2:1 to provide suitable polarity characteristics for mixing with the less polar polyketone.

A particularly suitable compatibilizer is e.g. an ethylene acrylic acid copolymer, preferably with a content of acrylic acid in a range of from 2 to 20 mol % and more preferably of from 7 to 15 mol %. Another particularly suitable compatibilizer is a maleic anhydride based compatibilizer such as a maleic anhydride grafted polyolefin.

The compatibilizer is regularly used in shortfall to the polymers of the blend, the mixing of which is to be improved by means of the compatibilizer. I.e. in a preferred embodiment, the compatibilizer is used in a quantity of 2 to 25 wt.-% and more preferably 4 to 10 wt.-% of the combined weight of the ethylene vinyl alcohol copolymer, the aliphatic polyketone and the compatibilizer.

In addition to the polymeric constituents described above, the blend may further contain one or more additives selected from one or more of antioxidants, heat stabilizers, ultraviolet absorbers, light stabilisers, slip agents, inorganic fillers, antistatic agents, flame retardants, crystallization modifiers such as crystallization accelerators or crystallization inhibitors, chain modification additives such as chain extenders (to e.g. improve extrusion behavior), chain breaking agents (e.g. to adjust processability), or chain branching agents, plasticisers, dyes, impact enhancers and the like.

The barrier layer has a thickness adapted for achieving the desired gas permeability. Preferably, the barrier layer has a thickness of at least 0.2 mm and less than 2.0 mm, with a thickness in the range of 0.5 to 1.5 mm being preferred. If the inventive hose is a hydrogen hose, the inner diameter of the barrier layer is preferably at least 6 mm, and more preferably in the range of 7 mm to 12 mm. If on the other hand, the inventive hose is a gasoline hose, the hose preferably has an inner diameter of the barrier layer of preferably at least 4 mm and not more than 25 mm.

To impart electrical conductivity, the barrier layer can contain an electrically conductive additive or filler.

Suitable electrically conductive additives or fillers are all fillers that can impart electrically conductive properties to the blend of ethylene vinyl alcohol copolymer and aliphatic polyketone, e.g. particulate, flaky or fibrous fillers.

Examples of suitable particulate fillers are carbon black and graphite. Examples of flaky filler that may be appropriately used include aluminium flakes, nickel flakes and nickel-coated mica. Examples of fibrous fillers include carbon fibres, carbon nanotubes, carbon coated ceramic fibres, carbon whiskers and metal fibres such as aluminium fibres, copper fibres, brass fibres and stainless steel fibres. Of these, carbon black and a mixture of carbon black and carbon nanotubes are most preferred as electrical conductivity mediating fillers.

Carbon black that may be used in the present invention includes any carbon black generally used to impart electrical conductivity. Preferred examples of carbon black include, but are not limited to, acetylene carbon black obtained by complete combustion of acetylene gas, Ketjen carbon black produced by furnace type incomplete combustion starting from crude oil, oil carbon black, naphthalene carbon black, thermal carbon black, lamp black, channel black, roller black and disc black. Of these, acetylene soot and furnace soot (Ketjen soot) are more preferred.

As for the carbon black, various carbon powders are produced which differ in properties such as particle size, surface area, DBP absorption and ash content. The carbon black that can be used in the present invention is not particularly limited with respect to these properties, but high structured carbon black and carbon black with a large aggregation density are preferred. With regard to impact strength, the carbon black is preferably not mixed in a large amount. To obtain excellent electrical conductivity with a smaller amount, the average particle size of carbon black is preferably 500 nm or less, more preferably 5 to 100 nm, and even more preferably 10 to 70 nm, the surface area (by BET method) is preferably 10 m²/g or more, more preferably 300 m²/g or more, and even more preferably 500 to 1.500 m²/g, and the DBP (dibutyl phthalate) absorption is preferably 50 ml/100 g or more, further preferably 100 ml/100 g or more, and still further preferably 300 ml/100 g or more. The ash content of carbon black is preferably 0.5% or less, and further preferably 0.3% or less. DBP absorption, as used herein, refers to a value measured according to the method prescribed in ASTM-D2414. A carbon black with a volatile content of less than 1.0% by weight is more preferred.

The electrically conductive filler may be surface treated with a surface treatment agent, such as a titanate, aluminium or silane type surface treatment agent. In addition, the electrically conductive filler may be particulate to improve processability when melt kneaded with the blend of ethylene vinyl alcohol copolymer and aliphatic polyketone.

When carbon black is used as the electrically conductive filler, it has surprisingly been found that this additive does not make the blend more permeable and unsatisfactorily brittle, but that it appears to act as nucleating agent on the polymer molecules thereby increasing the degree of crystallinity, and contributing to the permeation barrier properties, which become better with a higher degree of crystallinity due to the macromolecules being densely packed in the crystalline domains tantamount to a less free volume for permeation.

The amount of electrically conductive filler blended in is variable depending on the type of filler and cannot be specified independently, but in terms of the balance of electrical conductivity, melt flowability and mechanical strength, a proportion of electrically conductive filler 3 to 25 wt.-% of the barrier layer and preferably 6 to 20 wt.-% can be specified as favorable.

For the inventive hoses, it is moreover preferred that the inner barrier layer fulfil the requirements of the following inequation (see criteria 7.18.4 of ISO 19880-5):

$$log ( {V}_{B} \times T ) > \frac{1}{2} log ( {R}_{V} ) - 6$$

where V_{B} is the dielectric breakdown voltage (kV/mm) of the inner barrier layer material,

T is the thickness of the inner barrier tube of the hose in millimeters and

R_{V} is the volume resistivity of the inner barrier layer material.

Here, the thickness of the liner T is a design parameter of hose geometry that effects the validity of this inequation. I.e., if the dielectric breakdown voltage V_{B} is too low and/or the volume resistivity R_{V} is too high, the liner has to be thicker. A thicker liner might on the other hand affect the mechanical performance of the hose e.g. in terms of the flexibility.

The barrier layer of the blend of ethylene vinyl alcohol copolymer and aliphatic polyketone usually forms the innermost layer of the reinforced hose, but in individual cases another polymeric material can form the innermost layer and the barrier layer of aliphatic polyketone can be placed on it. In this case, the other material usually has a higher permeability for hydrogen than the barrier layer of the blend. Due to the negative influence of hydrogen and on metal and in particular steel at high pressure, the innermost layer of the high-pressure hose according to the invention is not a metal layer and in particular not a steel layer.

In addition, the reinforced hose according to the invention may have further polymer layers between the inner barrier layer and reinforcing layers, between reinforcing layers or between the outermost reinforcing layer and the outer layer formed from a polymeric material.

In addition to the barrier layer made of the blend of ethylene vinyl alcohol copolymer and aliphatic polyketone, the reinforced hose according to the invention additionally contains at least one reinforcing layer, whereby several reinforcing layers, i.e. e.g. two, three, four, five or six reinforcing layers are preferred. For preferred designs of reinforcing layers and their arrangements, reference can be made to the corresponding explanations in this respect, for example in EP 3 627 026 A1.

As noted above, the inventive reinforced hose has a burst pressure of at least 5.5 bar, in which case only minor reinforcement is necessary. In a preferred embodiment, the hose has a burst pressure of at least 17 bar, more preferably at least 50 bar, even more preferably at least 130 bar, even more preferably at least 1700 bar and most preferably least 3500 bar. As a reasonable upper limit, the burst pressure of the hose preferably does not exceed 5000 bar. For such hoses, it is apparent for the skilled person that the reinforcement has to be appropriate to provide the required burst pressure.

The burst pressure limit correlates with the fluid, which is transferred with the hose. E.g. if the fluid is a liquid under ambient conditions (such as gasoline) the burst pressure requirements for the hose can be less demanding, and it may be sufficient if the burst pressure is at least 5.5 bar, at least 17 bar or at least 50 bar. If on the other hand the hose is a hose for transferring hydrogen, which under ambient conditions is a gas, the burst pressure has to be higher to ensure safe operation.

Burst pressure conditions for hydrogen hoses are e.g. provided by DIN ISO 19880-5, with also provides other requirements for hydrogen hoses such as electrical conductivity. In DIN ISO 19880-5, several “qualities” of hydrogen hoses are described, which are designated as H11, H25, H35, H50 and H70. The pressure classification “H70” according to DIN ISO 19880-5 e.g. means, that the hose has an operating pressure of about 700 bar and a respective burst pressure, which is five times the operating pressure, i.e. 3500 bar. Similarly, the pressure classification “H35” according to DIN ISO 19880-5 means that the hose has an operating pressure of about 350 bar and a respective burst pressure of 1750 bar As the inventive barrier layer provides particularly favorable barrier characteristics towards hydrogen, in a preferred embodiment the inventive hose is at least a H11 hydrogen hose (burst pressure 550 bar), more preferably at least a H25 hydrogen hose (burst pressure 1250 bar), even more preferably at least a H35 hydrogen hose (burst pressure 1750 bar), more preferably at least a H50 hydrogen hose (burst pressure 2500 bar) and most preferably a H70 hose (burst pressure 3500 bar). Particularly preferably, the hose meets all requirements according to the respective “H”-level (e.g. “H70”) according to DIN ISO 19880-5.

In one embodiment, one or more reinforcement layers are formed from a woven, knitted or braided fibre material, whereby the fibres are sufficiently stable and have a strength suitable for absorbing high internal pressures. Preferred here are fibres with a tensile strength, determined according to DIN EN ISO 2062 (2010), of at least 2 GPa. The fibres may be formed from an organic polymer, e.g. polyamide, polyester, or polyethylene with a higher molecular weight, e.g. of more than 3,000,000 (UHMWPE). In one embodiment, the fibres are based on polyparaphenylene benzobisoxazole or UHMWPE. Advantageously, the strength member(s) may also be formed as a cord or tape of said materials with unidirectional orientation, particularly when the strength member is formed from UHMWPE.

Alternatively or additionally, one or more strength-bearing layer(s) may be formed of metal wire or metal strip, in particular metal wires and strips of steel, copper or copper alloy (according to JIS H 3260), aluminium or aluminium alloy (according to JIS H 4040), magnesium alloy (according to JIS H 4203), titanium or titanium alloy (according to JIS H 4670) may be used.

The inventive reinforced hose preferably further contains an outer layer, which is formed from a polymeric material. This polymeric material is not subject to any relevant restrictions, with the proviso that the material should be sufficiently flexible and stable over the service temperature of the hose. Preferred polymeric materials here are, for example, rubbers, such as chlorinated polyethylene rubber, epichlorhydrin rubber, chloroprene rubber, chloroprene acrylate rubber, butyl rubber, ethylene propylene rubber, chlorosulphonated polyethylene rubber, or thermoplastic polyurethane elastomer and thermoplastic materials, such as polyurethane, polyamide, e.g. polyamide 12, or polyester.

The outer layer will suitably have a thickness in the range of at least 0.2 mm and 1.5 mm or less, with a thickness in the range of at least 0.5 mm and 1.0 mm or less being preferred. The outer diameter of the outer layer is not subject to any relevant limitations, but will usually be at least 12 mm and 18 mm or less.

The outer layer can be continuous. Alternatively, the outer layer can have perforations through which gases, especially in the form of hydrogen, can escape from the inside to the outside of the hose in order to prevent the formation of bubbles or delamination.

In one embodiment, one or more layers of the hose are “bonded”, i.e. sliding of the layers against each other in the longitudinal direction of the hose is prevented by the bond. In a hose according to the invention, for example, the barrier layer may be bonded to adjacent reinforcing layers or the outermost reinforcing layer may be bonded to the outer layer formed from a polymeric material. In addition, all layers in the hose (with the possible exception of the reinforcing layers among each other) can also be connected to each other.

In another aspect, the present invention relates to a method of manufacturing a reinforced hose as described above, comprising the steps of:
applying a layer of a blend of ethylene vinyl alcohol copolymer and aliphatic polyketone to a mandrel or mandrel-less to form a barrier tube;
applying one or more reinforcement layers on the barrier tube;
optionally, applying an outer layer of a polymeric material to the one or more reinforcement layers.

The blend of ethylene vinyl alcohol copolymer and aliphatic polyketone is usually applied to a mandrel or without a mandrel from the melt, e.g. by extrusion.

In addition to reinforcement layers, the hose can further comprise one or more “friction” layers to mediate friction between different reinforcement layers, a reinforcement layer and the barrier layer or the reinforcement layer and an outer layer. Such frictions layers may also contribute to the reinforcement of the hose or provide other functions besides mediating friction.

In another aspect, the present invention relates to a device for filling a tank, which comprises a reinforced hose as described above. In addition to the hose, the device for filling a tank suitably comprises a dispensing device for fuel which is passed through the device and a closure device for connecting the dispensing device in a pressure-tight manner to a container into which a fuel (i.e. in particular hydrogen) is to be introduced.

In another aspect, the present invention relates to the use of a reinforced hose as described above for transferring hydrogen or other gases such as oxygen, helium, nitrogen, or halocarbon cooling agents such as those registers as Freons® from a storage container to a tank. Alternatively, the reinforced hose can also be used to for transferring low permeation gasoline fuel (including gasoline or blends of gasoline with ethanol or methanol, ethanol, methanol, diesel fuel, biodiesel (and blends thereof with diesel fuel) in automotive, aviation (jet fuel or kerosene) and industrial including curb pump dispensing hoses. The tank is particularly preferably the tank of an aircraft, ship, or vehicle, such as a passenger car, truck or rail vehicle.

In another aspect, the present invention relates to the use of a blend of ethylene vinyl alcohol copolymer and an aliphatic polyketone of the formula

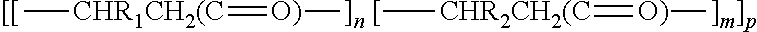

wherein R₁ and R₂ are different from each other and independently represent hydrogen or a C₁-C₁₂ alkyl group, n+m=1, and p is an integer, and wherein the two comonomers are randomly distributed or blocked, as a barrier layer material in a hose for transporting fluids or compressed gases such as hydrogen having a density of at least 24 kg/m³ and preferably in the range of 35 to 45 kg/m³. In another embodiment of this aspect, the blend of ethylene vinyl alcohol copolymer and an aliphatic polyketone is used as a liner material in a tank for storage of respective gases, wherein the tank on its inner surface has a coating of the respective blend.

For the foregoing, embodiments or configurations described above as being preferred or useful in one aspect of the invention are intended to be equally preferred or useful in all other aspects described, even if not explicitly recited. In addition, all preferred embodiments are deemed to be disclosed also as combinations of respective embodiments.

1. A reinforced hose having a burst pressure of at least 5.5 bar, wherein the hose has a layered structure comprising an inner barrier layer, at least one strength-bearing layer and optionally an outer layer formed from a polymeric material, and wherein the inner barrier layer is formed from a blend of ethylene vinyl alcohol copolymer and an aliphatic polyketone of the formula 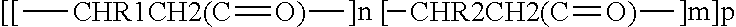
wherein R1 and R2 are different from each other and independently represent hydrogen or a C1-C12 alkyl group, n+m=1, and p is an integer, and wherein the two comonomers are randomly distributed or present as blocks.

2. The reinforced hose according to claim 1, wherein the ethylene vinyl alcohol copolymer comprises units derived from ethylene in an amount of form 23 to 35 mol.-% and preferably from 24 to 30 mol.-%.

3. The reinforced hose according to claim 1, where the ratio of ethylene vinyl alcohol copolymer to aliphatic polyketone is from 10:90 to 60:40 and preferably from 20:80 to 45:55.

4. The hose according to claim 1, wherein the blend of ethylene vinyl alcohol copolymer and aliphatic polyketone further comprises a compatibilizer, preferably in the form of an ethylene acrylic acid copolymer, wherein more preferably the compatibilizer accounts for 2 to 25 wt.-% and especially 4 to 10 wt.-% of the combined weight of ethylene vinyl alcohol copolymer, aliphatic polyketone and compatibilizer.

5. The reinforced hose according to claim 1, wherein the barrier layer is formed as an inner layer with a layer thickness of at least 0.2 mm and less than 2.0 mm, and preferably in the range of 0.5 to 1.5 mm.

6. The reinforced hose according to claim 1, wherein the barrier layer contains an electrical conductivity mediating filler, preferably selected from one or more of carbon black, carbon fibres, carbon nanotubes, carbon coated ceramic fibres, carbon whiskers and metal fibres, such as aluminium fibres, copper fibres, brass fibres and stainless steel fibres, preferably in the form of carbon black or a combination of carbon black and carbon nanotubes, wherein more preferably the filler accounts for 3 to 25 wt.-% and even more preferably 6 to 20 wt.-% of the barrier layer.

7. The reinforced hose according to claim 1, wherein the blend, which forms the barrier layer, has a gas permeability to hydrogen (H2) of 1000 mm*cm3*m−2*d−1 bar−1 or less (determined according to DIN 53880 (2006) at 30° C. and 30 bar, 0% relative humidity)), in particular 800 mm*cm3*m⁻²*d−1 bar−1 or less and preferably 500 mm*cm3*m−2*d−1 bar−1 or less.

8. The reinforced hose according to claim 1, wherein the hose comprises at least one strength-bearing layer formed from high-strength organic fibres, wherein the fibres have a tensile strength, determined according to DIN EN ISO 2062, of at least 2 GPa, or a strength-bearing layer formed of metal wire, said metal wire preferably being formed of steel, copper or copper alloy (according to JIS H 3260), aluminium or aluminium alloy (according to JIS H 4040), magnesium alloy (according to JIS H 4203), titanium or titanium alloy (according to JIS H 4670).

9. The reinforced-reinforced hose according to claim 1, wherein the hose has an outer layer which is formed from a polymeric material selected from a rubber and/or a thermoplastic material, wherein the rubber or thermoplastic material is preferably selected from chlorinated polyethylene rubber, epichlorohydrin rubber, chloroprene rubber, chloroprene acrylate rubber, butyl rubber, ethylene propylene rubber, chlorosulphonated polyethylene rubber, polyurethane, polyamide and polyester.

10. The reinforced hose according to claim 1, wherein the outer layer formed from a polymeric material has perforations.

11. The reinforced hose according to claim 1, wherein the hose has an inner diameter of at least 6 mm and preferably 7 mm to 12 mm.

12. A method of manufacturing a reinforced hose according to claim 1, comprising:
applying a layer of a blend of a ethylene vinyl alcohol copolymer and an aliphatic polyketone to a mandrel or without a mandrel to form a barrier tube;
applying of one or more reinforcement layers on the barrier tube;
optionally applying one or more friction layers, and
optionally applying an outer layer of a polymeric material to the one or more reinforcement layers.

13. A device for filling a tank comprising a reinforced hose according to claim 1.

14. A method comprising: providing the reinforced hose according to claim 1 and using the hose for transferring hydrogen from a storage container into a tank, preferably a tank of a vehicle or aircraft or ship.

15. A method comprising: providing a blend of an ethylene vinyl alcohol copolymer and an aliphatic polyketone of the formula 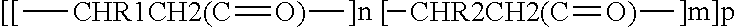
wherein R1 and R2 are different from each other and independently represent hydrogen or a C1-C12 alkyl group, n+m=1, and p is an integer, and wherein the two comonomers are randomly distributed or blocked, and
using the blend as a barrier layer material in a hose for transporting fluids or compressed gases, preferably in the form of hydrogen having a density of at least 24 kg/m3 and in particular in the range of 35 to 45 kg/m³, or as a liner in a tank for storage of respective gases.
